(19) United States
(12) Patent Application Publication
(10) Pub. No.: US 2026/0039192 A1
(43) Pub. Date: Feb. 5, 2026

(54) CONVERSION CIRCUIT

(71) Applicant: LITE-ON TECHNOLOGY CORPORATION, TAIPEI CITY (TW)

(72) Inventors: Kai-De CHEN, TAIPEI CITY (TW); Yong-Long SYU, TAIPEI CITY (TW); Han-Min HUANG, TAIPEI CITY (TW); Cheng-Wei TSENG, TAIPEI CITY (TW); Chen CHEN, TAIPEI CITY (TW)

(21) Appl. No.: 19/280,502

(22) Filed: Jul. 25, 2025

Related U.S. Application Data
(60) Provisional application No. 63/679,319, filed on Aug. 5, 2024.

(30) Foreign Application Priority Data
May 27, 2025 (CN) 202510689741.3

(51) Int. Cl. H02M 3/00; H01F 27/26; H01F 27/28; H01F 27/29; H02M 3/158

(52) U.S. Cl. CPC H02M 3/003; H01F 27/26; H01F 27/2828; H01F 27/29; H02M 3/01; H02M 3/1582

(57) ABSTRACT

A conversion circuit is configured in a power converter. The conversion circuit includes a first inductor core, a first wiring and a second wiring. The first inductor core includes a core pillar. The first wiring surrounds the core pillar to form a first inductor coil. The second wiring surrounds the core pillar to form a second inductor coil, and the first wiring and the second wiring are located in same electrically conductive circuit. A power signal of the first wiring transmits into an electronic circuit and transmits out to the second wiring.

### CROSS REFERENCE TO RELATED APPLICATIONS

This application claims priority of U.S. provisional application No. 63/679,319, filed on Aug. 5, 2024, the entirety of which is incorporated by reference herein.

This application claims priority of China patent application No. 202510689741.3, filed May 27, 2025, the entirety of which is incorporated by reference herein.

### BACKGROUND OF THE INVENTION

### Field of the Invention

The present invention relates to a conversion circuit, and, in particular, to a conversion circuit configured to use with an inductor.

### Description of the Related Art

Currently, traditional printed circuit board (PCB) traces are feasible for general circuit applications. However, in low-voltage, high-current applications, conventional PCB traces tend to result in excessive copper loss.

Accordingly, a conversion circuit that optimizes PCB routing to reduce copper loss is a subject that urgently requires research and development.

### BRIEF SUMMARY OF THE INVENTION

The Summary of the Invention aims to provide a simplified summary of the present disclosure, so that readers can have a basic understanding of the present disclosure. This Summary of the Invention is not a complete overview of the present disclosure, and its intention is not to point out important/key elements of the embodiments of the present application or to define the scope of the present application.

An embodiment of the present invention provides a conversion circuit. The conversion circuit is configured in a power converter. The conversion circuit includes a first inductor core, a first wiring, and a second wiring. The first inductor core includes a core pillar. The first wiring surrounds the core pillar to form a first inductor coil. The second wiring surrounds the core pillar to form a second inductor coil, and the first wiring and the second wiring are located in same electrically conductive circuit. A power signal of the first wiring transmits into an electronic circuit and transmits out to the second wiring.

In one embodiment, the first inductor core further comprises a first pillar and a second pillar; wherein the core pillar is located between the first pillar and the second pillar, and the first pillar, the core pillar, and second pillar are arranged along a normal line; wherein the first wiring and the second wiring respectively pass through the normal line; wherein the first wiring is arranged between the first pillar and the core pillar.

In one embodiment, the first pillar comprises a first cross-sectional area, the core pillar comprises a second cross-sectional area, and the second pillar comprises a third cross-sectional area; wherein the second cross-sectional area is greater than the first cross-sectional area, the second cross-sectional area is greater than the third cross-sectional area.

In one embodiment, the first cross-sectional area is equal to the third cross-sectional area.

In one embodiment, the first inductor core further comprises a groove, and the groove is configured to receive at least one of capacitor; wherein the first wiring and the second wiring are coupled to the at least one of capacitor.

In one embodiment, the groove is arranged adjacent to the core pillar.

In one embodiment, the groove is disposed at a central portion of the first inductor core.

In one embodiment, the electronic circuit comprises at least one electronic component, and the electronic circuit is respectively coupled to one terminal of the first wiring and the second wiring; wherein another electronic circuit comprises at least one other electronic component, and the another electronic circuit is respectively coupled to other terminal of the first wiring and the second wiring.

In one embodiment, the conversion circuit further includes a first switch and a second switch. Wherein the first wiring is coupled to a power supply, the first wiring is coupled to the first switch and second switch, and the first switch and the second switch are respectively coupled to an output capacitor and a resistor; wherein the at least one electronic component of the electronic circuit comprises at least one of an input capacitor and the power supply; wherein the at least one other electronic component of the another electronic circuit comprises at least one of the first switch, the second switch, the output capacitor, and the resistor.

In one embodiment, the conversion circuit further includes a first switch and a second switch. Wherein the first switch and the second switch are respectively coupled to a power supply and an input capacitor, the first wiring is coupled to the first switch and the second switch, and the first wiring is coupled to a resistor; wherein the at least one electronic component of the electronic circuit comprises at least one of the first switch, the second switch, the input capacitor, and the power supply; wherein the at least one other electronic component of the another electronic circuit comprises at least one of an output capacitor and the resistor.

In one embodiment, the conversion circuit further includes a first switch, a second switch, a third switch, a fourth switch, and a first transformer coil. Wherein the first wiring id coupled to a power supply, the first wiring is coupled to the first switch, the second switch, the third switch, and the fourth switch, and the first switch and the fourth switch are respectively coupled to the first transformer coil; wherein the at least one electronic component of the electronic circuit comprises at least one of an input capacitor and the power supply; wherein the at least one other electronic component of the another electronic circuit comprises at least one of the first switch, the second switch, the third switch, the fourth switch, and the first transformer coil.

In one embodiment, the conversion circuit further includes a fifth switch, a sixth switch, a seventh switch, an eighth switch, and a second transformer coil. Wherein the fifth switch and the eighth switch are respectively coupled to the second transformer coil; wherein the fifth switch, the sixth switch, the seventh switch and the eighth switch are respectively coupled to an output capacitor and a resistor; wherein the at least one other electronic component of the another electronic circuit comprises at least one of the fifth switch, the sixth switch, the seventh switch, the eighth switch and the second transformer coil.

In one embodiment, the conversion circuit further includes a first switch, a second switch, a third switch, a fourth switch, and a first transformer coil. Wherein the first wiring is coupled to the first switch, the second switch, the third switch, and the fourth switch; where in the first switch and the fourth switch are respectively coupled to the first transformer coil, and the first wiring is coupled to a resistor; wherein the at least one electronic component of the electronic circuit comprises at least one of the first switch, the second switch, the third switch, the fourth switch, and the first transformer coil; wherein the at least one other electronic component of the another electronic circuit comprises at least one of an output capacitor and the resistor.

In one embodiment, the conversion circuit further includes a fifth switch, a sixth switch, and a second transformer coil. Wherein the fifth switch and the sixth switch are respectively coupled to a power supply and an input capacitor, and the fifth switch and the sixth switch are respectively coupled to a first intermediate capacitor and a second intermediate capacitor; wherein the at least one electronic component of the electronic circuit comprises at least one of the fifth switch, the sixth switch, the second transformer coil, the first intermediate capacitor, and the second intermediate capacitor.

In one embodiment, the conversion circuit is used in one of a boost-type conversion device, a buck-type conversion device, a current-fed conversion device, and a resonant-type power conversion device.

In one embodiment, the first wiring and the second wiring are located on same side of a transformer.

In one embodiment, a first current value of the first wiring is equal to a second current value of the second wiring.

In one embodiment, a number of turns of a first inductor coil of the first wiring is not equal to a number of turns of a second inductor coil of the second wiring.

In one embodiment, a number of turns of a first inductor coil of the first wiring is greater than a number of turns of a second inductor coil of the second wiring.

In one embodiment, a number of turns of a first inductor coil of the first wiring is equal to a number of turns of a second inductor coil of the second wiring.

Therefore, according to the technical content of the present disclosure, the conversion circuit shown in the embodiment of the present disclosure can achieve the effect reducing conductor material loss by optimizing the arrangement of the first wiring and the second wiring.

Other features and aspects of the present disclosure will become apparent from the following detailed description of exemplary embodiments with reference to the accompanying drawings.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a conversion circuit according to one embodiment of the present disclosure.

FIG. 2A is a detailed circuit diagram of a conversion circuit according to one embodiment of the present disclosure.

FIG. 2B is a circuit diagram of a conversion circuit according to one embodiment of the present disclosure.

FIG. 3A is a structural diagram of a first inductor core of a conversion circuit according to one embodiment of the present disclosure.

FIG. 3B is a structural diagram of a first inductor core of a conversion circuit according to one embodiment of the present disclosure.

FIG. 4A is a circuit diagram of a conversion circuit according to one embodiment of the present disclosure.

FIG. 4B is a circuit diagram of a conversion circuit according to one embodiment of the present disclosure.

FIG. 4C is a circuit diagram of a conversion circuit according to one embodiment of the present disclosure.

FIG. 5 is a detailed circuit diagram of a conversion circuit according to one embodiment of the present disclosure.

FIG. 6 is a detailed circuit diagram of a conversion circuit according to one embodiment of the present disclosure.

FIG. 7 is a detailed circuit diagram of a conversion circuit according to one embodiment of the present disclosure.

FIG. 8 is a detailed circuit diagram of a conversion circuit according to one embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

To make the description of the present disclosure more detailed and complete, illustrative descriptions of the implementation aspects and exemplary embodiments of the present application are provided below; however, this is not the only form for implementing or using the exemplary embodiments of the present application. The embodiments cover features of multiple exemplary embodiments and method steps and their sequences used to construct and operate these exemplary embodiments. However, the same or equivalent functions and step sequences can also be achieved using other exemplary embodiments.

Unless otherwise defined in this specification, the meaning of scientific and technical terms used herein is the same as understood and customarily used by a person having ordinary skill in the art to which the present application pertains. Furthermore, without conflicting with the context, singular nouns used in this specification cover the plural form of the noun; and plural nouns used also cover the singular form of the noun.

In addition, regarding “coupled” or “connected” as used herein, it may refer to two or more elements being in direct physical or electrical contact with each other, or being in indirect physical or electrical contact with each other, or it may refer to two or more elements mutually operating or acting.

Some embodiments of the present disclosure can be understood in conjunction with the drawings. The drawings of the embodiments of the present disclosure are also considered a part of the description of the embodiments of the present disclosure. It should be understood that the drawings of the embodiments of the present disclosure are not drawn to the actual proportions of devices and elements. In the drawings, the shape and thickness of the embodiments may be exaggerated to clearly illustrate the features of the embodiments of the present disclosure. Furthermore, structures and devices in the drawings are schematically illustrated to clearly illustrate the features of the embodiments of the present disclosure.

Herein, the term “device” generally refers to an object comprising one or more transistors and/or one or more active and/or passive components connected in a certain manner to process signals.

Herein, the terms “about,” “approximately,” and “substantially” generally indicate within 20% of a given value or range, preferably within 10%, and more preferably within 5%, or within 3%, or within 2%, or within 1%, or within 0.5%. Here, a given quantity is an approximate quantity, meaning that even without specific mention of “about,” “approximately,” or “substantially,” the meaning of “about,” “approximately,” or “substantially” can still be implied.

Certain terms are used in the specification and the claims to refer to specific elements. However, a person having ordinary skill in the art should understand that the same elements may be referred to by different names. The specification and the claims do not use differences in names as a way to distinguish elements, but rather use differences in function of the elements as the basis for distinction. The term “comprising” as mentioned in the specification and the claims is an open-ended term, and thus should be interpreted as “comprising but not limited to”.

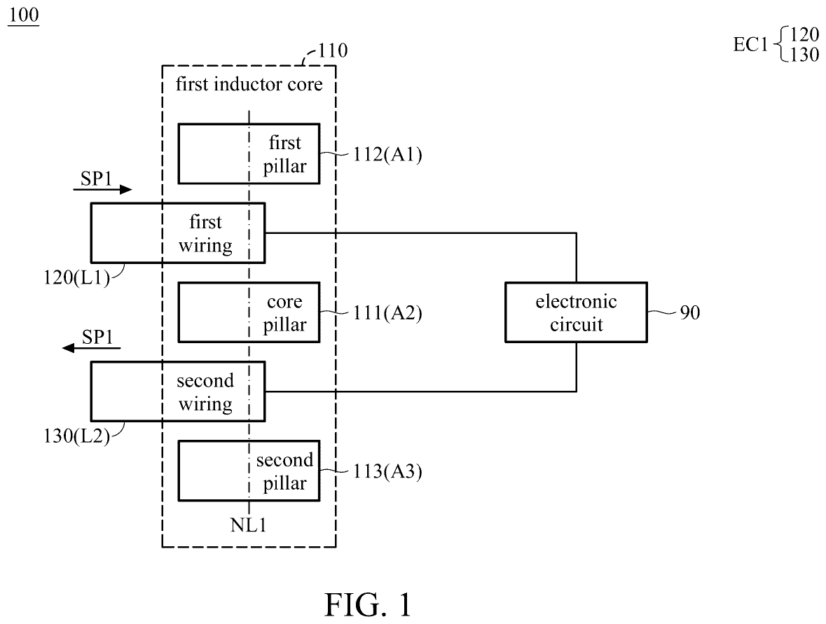

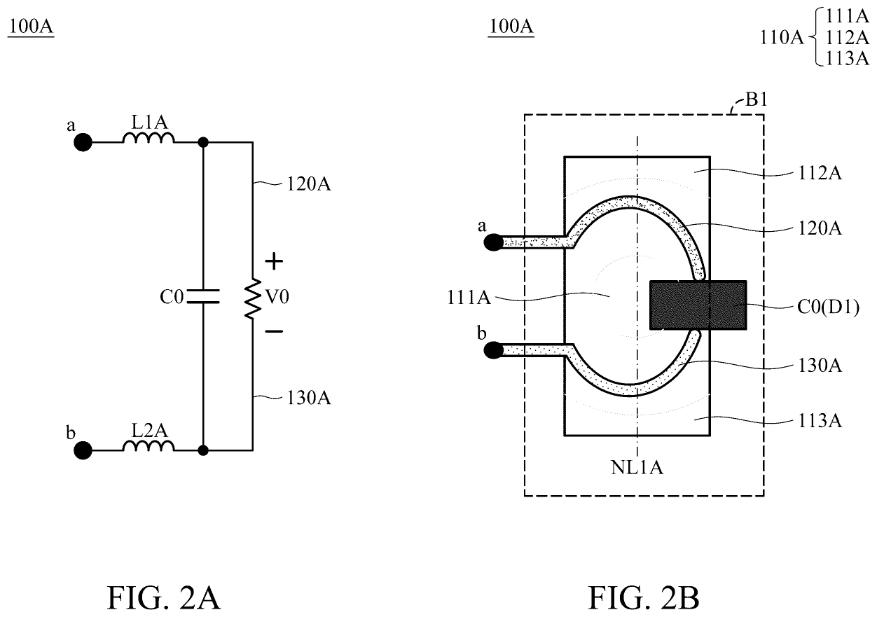

In order to explain the relationship between the technology and structure in detail, FIGS. 1 through 2B will be described sequentially, followed by an integrated explanation of their technical and structural relationships, so as to facilitate the reader's understanding of the present disclosure.

FIG. 1 is a block diagram of a conversion circuit according to one embodiment of the present disclosure. As shown in FIG. 1, in one embodiment, the conversion circuit 100 includes a first inductor core 110, a first wiring 120, and a second wiring 130. The first inductor core 110 includes a core pillar 111.

For example, the first inductor core 110 may be a magnetic core structure of any type of inductor, the core pillar 111 may be a magnet or magnetic column of any shape, the first wiring 120 may be a PCB trace or a metal wire, such as copper wire, the second wiring 130 may be a PCB trace or a metal wire, but the present disclosure is not limited thereto. In some embodiments, the first wiring 120 and the second wiring 130 may be connected to each other, but the present disclosure is not limited thereto. In some embodiments, the first wiring 120 and the second wiring 130 may be not connected to each other, but the present disclosure is not limited thereto.

In this embodiment, the conversion circuit 100 is configured in a power converter. For example, the conversion circuit 100 may be used in a power converter, the power converter may include a transformer or a rectifier, but the present disclosure is not limited thereto.

In one embodiment, the first inductor core further includes a first pillar 112 and a second pillar 113. The core pillar 111 is located between the first pillar 112 and the second pillar 113, and the first pillar 112, the core pillar 111, and the second pillar 113 are arranged along a normal line NL1. The first wiring 120 and the second wiring 130 respectively pass through the normal line NL1. The first wiring 120 is arranged between the first pillar 112 and the core pillar 111.

For example, the first pillar 112 may be a magnetic column or a magnetic material of any shape, second pillar 113 may be the magnetic column or the magnetic material of any shape, but the present disclosure is not limited thereto.

In some embodiments, the first pillar 112 and the second pillar 113 may have the same or similar shapes, but the present disclosure is not limited thereto. In some embodiments, the core pillar 111, the first pillar 112, and the second pillar 113 may have the same or similar shapes, but the present disclosure is not limited thereto. In some embodiments, the shapes and positions of the first pillar 112 and the second pillar 113 may be symmetrical or corresponding to each other, but the present disclosure is not limited thereto.

In some embodiments, the second wiring 130 is arranged between the second pillar 113 and the core pillar 111. In some embodiments, the first pillar 112, the first wiring 120, the core pillar 111, the second wiring 130, and the second pillar 113 may be sequentially arranged along a normal line NL1, but the present disclosure is not limited thereto.

In some embodiments, the first wiring 120 is coupled to the electronic circuit 90, and the second wiring 130 is coupled to the electronic circuit 90. For example, the electronic circuit 90 may be a circuit that includes any type of the electronic components, such as the resistors, the capacitors, the switches, the power supplies, or the transformers, but the present disclosure is not limited thereto.

In some embodiments, the first wiring 120 has a first inductance L1, and the second wiring 130 has a second inductance L2. For example, the first wiring 120 may form the first inductance L1 together with the first pillar 112 and the core pillar 111, the second wiring 130 may form the second inductance L2 together with the second pillar 113 and the core pillar 111, but the present disclosure is not limited thereto.

In some embodiments, the first wiring 120 may be coupled to the positive terminal of the power supply, the second wiring 130 may be coupled to the negative terminal (or ground) of the power supply, but the present disclosure is not limited thereto. In some embodiments, an electrically conductive circuit EC1 may be formed by the first wiring 120 and the second wiring 130, but the present disclosure is not limited thereto.

FIG. 2A is a detailed circuit diagram of a conversion circuit according to one embodiment of the present disclosure. As shown in FIG. 2A, in one embodiment, the conversion circuit 100 may include the first wiring 120A having the first inductance LIA formed by the first inductor coil, the second wiring 130A having the second inductance L2A formed by the second inductor coil, a capacitor CO, and the resistor RL. The resistor RL has a voltage VO. Regarding the connection arrangement, the first wiring 120A is coupled to the capacitor CO, the second wiring 130A is coupled to the capacitor CO, the first wiring 120A is coupled to the resistor RL, and the second wiring 130A is coupled to the resistor RL.

For example, the first inductance LIA, the first wiring 120A, the second inductance L2A, and the second wiring 130A in FIG. 2A may respectively correspond to the first inductance L1, the first wiring 120, the second inductance L2, and the second wiring 130 in FIG. 1, but the present disclosure is not limited thereto.

In some embodiments, the first inductance LIA is located on the first wiring 120A, the second inductance L2A is located on the second wiring 130A, but the present disclosure is not limited thereto. In some embodiments, first wiring 120A may have the first terminal a, the second wiring 130A may have the second terminal b, but the present disclosure is not limited thereto.

FIG. 2B is a circuit diagram of a conversion circuit according to one embodiment of the present disclosure. As shown in FIG. 2B, in one embodiment, the conversion circuit 100 may include a printed circuit board (PCB) B1, the core pillar 111A, the first pillar 112A, the second pillar 113A, the first wiring 120A, the second wiring 130A, the capacitor CO, the first terminal a, and the second terminal b. Regarding the connection arrangement, the first wiring 120A may be coupled to the capacitor CO, the second wiring 130A may be coupled to the capacitor CO.

For example, FIG. 2B may be a schematic diagram of a hardware architecture of FIG. 2A, the core pillar 111A, the first pillar 112A, the second pillar 113A, the first wiring 120A, and the second wiring 130A in FIG. 2B may respectively correspond to the core pillar 111, the first pillar 112, the second pillar 113, the first wiring 120, and the second wiring 130 in FIG. 1, but the present disclosure is not limited thereto. In some embodiments, the core pillar 111A, the first pillar 112A, the second pillar 113A, the first wiring 120A, the second wiring 130A, and the capacitor CO may be located on the printed circuit board (PCB) B1, but the present disclosure is not limited thereto.

In some embodiments, the core pillar 111A, the first pillar 112A, and the second pillar 113A may collectively constitute the first inductor core 110A, the first inductor core 110A may have the groove D1, and the capacitor CO may be disposed within the groove D1, but the present disclosure is not limited thereto. In some embodiments, the first pillar 112A, the first wiring 120A, the core pillar 111A, the second wiring 130A, and the second pillar 113A may be sequentially arranged along the normal line NL1A, and the first wiring 120A and second wiring 130A may respectively extend across the normal line NL1A, but the present disclosure is not limited thereto.

Please refer to FIG. 1 to FIG. 2B, in one embodiment, the first wiring 120A surrounds the core pillar 111A to form the first inductor coil LIA. The second wiring 130A surrounds the core pillar 111A to form the second inductor coil L2A, and the first wiring 120A and the second wiring 130A are located in the same electrically conductive circuit EC1. A power signal SP1 (as shown in FIG. 1) of the first wiring 120A transmits into the electronic circuit 90 and transmits out to the second wiring 130A.

For example, the power signal SP1 may be supplied from the power supply, an inductance value of the first inductor coil LIA may be approximately equal to an inductance value of the second inductor coil L2A, the first wiring 120A and the second wiring 130A may form the electrically conductive circuit EC1, but the present disclosure is not limited thereto.

In one embodiment, a first current value of first wiring 120A is equal to a second current value of the second wiring 130A.

For example, the first current value of the first wiring 120A may correspond to the second current value of the second wiring 130A, the first current value of the first wiring 120A may have a proportional relationship with the second current value of the second wiring 130A, but the present disclosure is not limited thereto.

In one embodiment, a number of turns of the first wiring 120A is not equal to a number of turns of the second wiring 130A.

For example, the number of turns of the first inductor coil may be 0.5 times or more of a reference number of turns, the number of turns of the second inductor coil may be 0.5 times or more of the reference number of turns, and the number of turns of the first inductor coil may be different from the number of turns of the second inductor coil, but the present disclosure is not limited thereto.

In one embodiment, a number of turns of the first wiring 120A is greater than a number of turns of the second wiring 130A.

For example, the number of turns of the first inductor coil may be greater than the number of turns of the second inductor coil by at least 1 full turn, such as based on a unit difference of 1 turn, the number of turns of the first inductor coil may be 0.5, and the number of turns of the second inductor coil may be 1.5, but the present disclosure is not limited thereto. The number of turns of the first inductor coil may be 0.5×N1, and the number of turns of the second inductor coil may be 0.5×N2, where N1 and N2 are positive odd integers. N1 and N2 may be the same or different. Together, the two coils form a complete inductor with an integer number of turns.

In one embodiment, a number of turns of first inductor coil of the first wiring 120A is equal to a number of turns of the second inductor coil of the second wiring 130A.

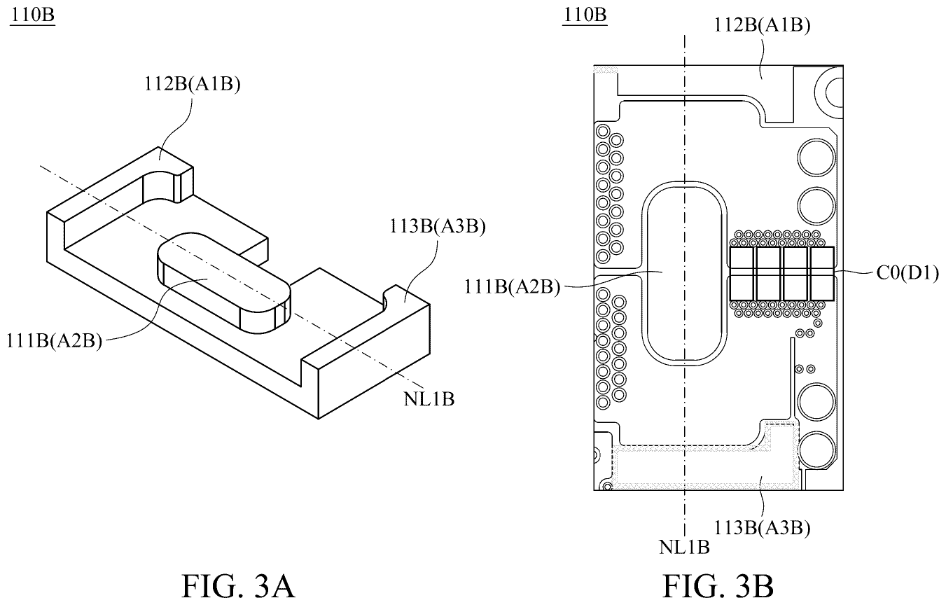

FIG. 3A is a structural diagram of a first inductor core of a conversion circuit according to one embodiment of the present disclosure. As shown in FIG. 3A, in one embodiment, the first inductor core 110B includes a core pillar 111B, a first pillar 112B, and a second pillar 113B.

For example, the first inductor core 110B, the core pillar 111B, the first pillar 112B, and the second pillar 113B shown in FIG. 3A may correspond to the first inductor core 110, the core pillar 111, the first pillar 112, and the second pillar 113 shown in FIG. 1, but the present disclosure is not limited thereto. In some embodiments, FIG. 3A may be a perspective view of the first inductor core 110 shown in FIG. 1, but the present disclosure is not limited thereto.

FIG. 3B is a structural diagram of a first inductor core of a conversion circuit according to one embodiment of the present disclosure. As shown in FIG. 3B, in one embodiment, the first inductor core 110B includes a core pillar 111B, a first pillar 112B, and a second pillar 113B.

In some embodiments, FIG. 3B may be a top view schematic of the first inductor core 110B shown in FIG. 3A, but the present disclosure is not limited thereto.

Please refer to FIG. 3A and FIG. 3B, in one embodiment, the first pillar 112B includes a first cross-sectional area A1B, the core pillar 111B includes a second cross-sectional area A2B, and the second pillar 113B includes a third cross-sectional area A3B. The second cross-sectional area A2B is greater than the first cross-sectional area A1B, and the second cross-sectional area A2B is greater than the third cross-sectional area A3B.

In some embodiments, the second cross-sectional area A2B may be approximately twice the first cross-sectional area A1B, but the present disclosure is not limited thereto. In some embodiments, the second cross-sectional area A2B may be approximately twice the third cross-sectional area A3B, but the present disclosure is not limited thereto.

In one embodiment, first cross-sectional area A1B is equal to the third cross-sectional area A3B. For example, the first cross-sectional area A1B may be approximately equal to the third cross-sectional area A3B, but the present disclosure is not limited thereto.

In some embodiments, a volume of the core pillar 111B is greater than a volume of the first pillar 112B, and the volume of the core pillar 111B is greater than a volume of the second pillar 113B. For example, the volume of the core pillar 111B may be approximately twice the volume of the first pillar 112B, and the volume of the first pillar 112B may be approximately equal to the volume of the second pillar 113B, but the present disclosure is not limited thereto.

In some embodiments, the number of the core pillar 111B may be plural, for example, two. In this case, the volume (or the cross-sectional area) of the core pillar 111B may be approximately equal to the volume (or the cross-sectional area) of the first pillar 112B, and the volume (or the cross-sectional area) of the core pillar 111B may be approximately equal to the volume (or the cross-sectional area) of the second pillar 113B, but the present disclosure is not limited thereto.

In one embodiment, the first inductor core further includes a groove D1, and the groove D1 is configured to receive at least one of capacitor CO. The first wiring and the second wiring is coupled to the at least one of capacitor CO.

In one embodiment, the groove D1 is arranged adjacent to the core pillar 111B. For example, the groove D1 may be disposed outside the core pillar 111B, the groove D1 may be located at any position within the first inductor core 110B, but the present disclosure is not limited thereto.

In one embodiment, the groove D1 is disposed at a central portion of the first inductor core 110B. For example, the groove D1 may be disposed at a center of the first inductor core 110B, and/or the groove D1 may be disposed at a center of the core pillar 111B, but the present disclosure is not limited thereto.

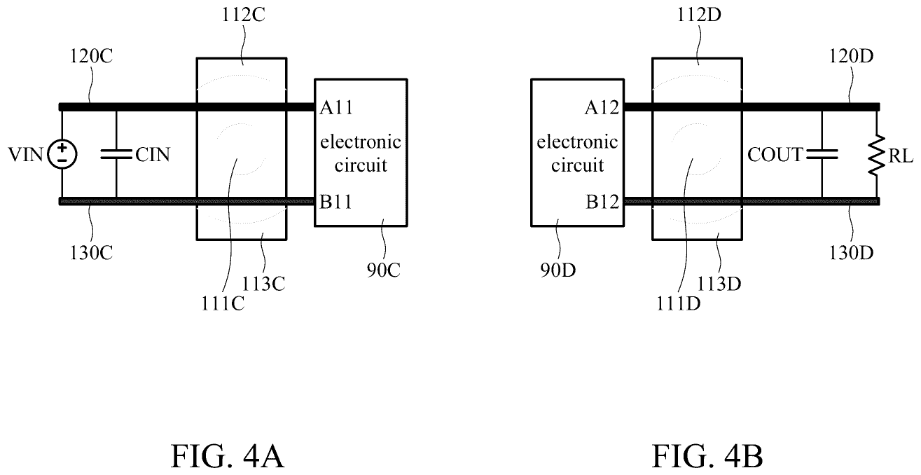

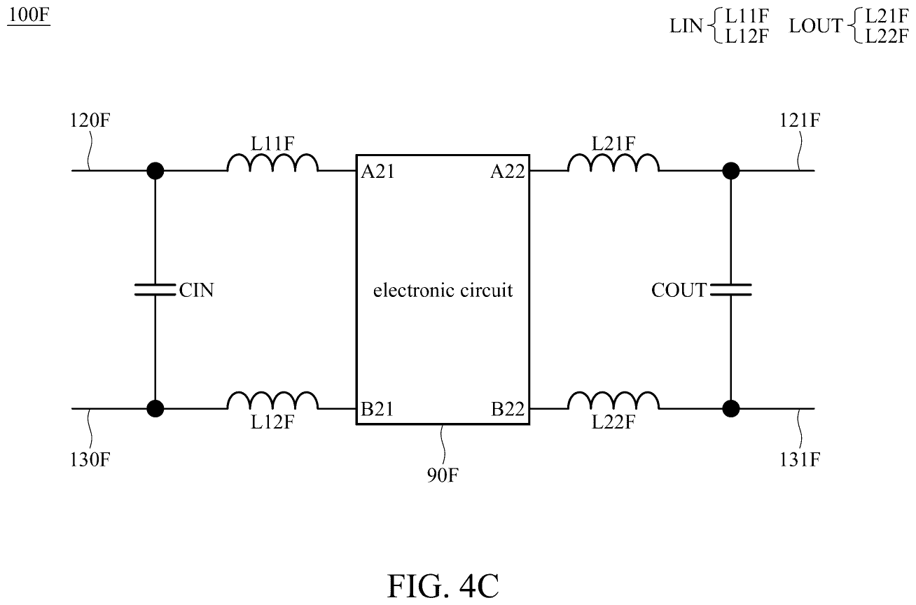

FIG. 4A is a circuit diagram of a conversion circuit according to one embodiment of the present disclosure. As shown in FIG. 4A, in one embodiment, the conversion circuit 100C has the power supply VIN, the capacitor CIN, the core pillar 111C, the first pillar 112C, the second pillar 113C, the first wiring 120C, the second wiring, the 130C, and the electronic circuit 90C. Regarding the connection arrangement, the first wiring 120C may be connected to a terminal A11 of the electronic circuit 90C, and the second wiring 130C may be connected to a terminal B11 of the electronic circuit 90C.

For example, the core pillar 111C, the first pillar 112C, the second pillar 113C, the first wiring 120C, the second wiring 130C, and the electronic circuit 90C shown in FIG. 4A may correspond to the core pillar 111, the first pillar 112, the second pillar 113, the first wiring 120, the second wiring 130, and the electronic circuit 90 shown in FIG. 1, but the present disclosure is not limited thereto.

In some embodiments, the conversion circuit 100C may be regarded as an input (inductor) structure, primarily used for receiving the power supply or the power signal SP1 (as shown in FIG. 1), but the present disclosure is not limited thereto.

FIG. 4B is a circuit diagram of a conversion circuit according to one embodiment of the present disclosure. As shown in FIG. 4B, in one embodiment, the conversion circuit 100D has the capacitor COUT, the resistor RL, the core pillar 111D, the first pillar 112D, the second pillar 113D, the first wiring 120D, the second wiring 130D, and the electronic circuit 90D. Regarding the connection arrangement, the first wiring 120D may be connected to a terminal A12 of the electronic circuit 90D, and the second wiring 130D may be connected to a terminal B12 of the electronic circuit 90D.

For example, the core pillar 111D, the first pillar 112D, the second pillar 113D, the first wiring 120D, the second wiring 130D, and the electronic circuit 90D shown in FIG. 4B may correspond to the core pillar 111, the first pillar 112, the second pillar 113, the first wiring 120, the second wiring 130, and the electronic circuit 90 shown in FIG. 1, but the present disclosure is not limited thereto.

In some embodiments, the conversion circuit 100D may be regarded as an output (inductor) structure, primarily used for outputting a converted signal or transmitting a signal, but the present disclosure is not limited thereto.

Please refer to FIG. 4A and FIG. 4B, in one embodiment, the electronic circuit 90C includes at least one electronic component (such as switches or transformer), and electronic circuit 90C is respectively coupled to a terminal of the first wirings 120C and 120D, and a terminal of the second wirings 130C and 130D, such as terminal A11 and terminal B11. Another electronic circuit 90D include at least one other electronic component (such as switches or transformer), and the another electronic circuit 90D is respectively coupled to a terminal of the first wiring 120C and 120D, and a terminal of the second wiring 130C and 130D, such as the terminal A12 and the terminal B12.

For example, the first wiring 120C may be coupled to the first wiring 120D, the second wiring 130C may be coupled to the second wiring 130D, and the electronic circuit 90C may be coupled to the another electronic circuit 90D, but the present disclosure is not limited thereto.

In some embodiments, the electronic circuit 90C may be the same as the another electronic circuit 90D, but the present disclosure is not limited thereto. In some embodiments, the electronic circuit 90C may be different from the another electronic circuit 90D, but the present disclosure is not limited thereto.

FIG. 4C is a circuit diagram of a conversion circuit according to one embodiment of the present disclosure. As shown in FIG. 4C, in one embodiment, the conversion circuit 100F has the capacitor CIN, an inductor L11F, an inductor L12F, the electronic circuit 90F, an inductor L21F, an inductor L22F, the capacitor COUT, the first wiring 120F and 121F, and the second wiring 130F and 131F. The electronic circuit 90F has a plurality of terminals A21, A22, B21, and B22.

Regarding the connection arrangement, the first wiring 120F may be connected to a terminal A21 of the electronic circuit 90F, the second wiring 130F may be connected to a terminal B21 of the electronic circuit 90F, the first wiring 121F may be connected to a terminal A22 of the electronic circuit 90F, and the second wiring 131F may be connected to a terminal B22 of the electronic circuit 90F.

For example, the electronic circuit 90F, the first wiring 120F and 121F, and the second wiring 130F and 131F shown in FIG. 4C may correspond to the electronic circuit 90, the first wiring 120, and the second wiring 130F shown in FIG. 1, but the present disclosure is not limited thereto.

In some embodiments, the inductor L11F and the inductor L12F shown in FIG. 4C may correspond to the first inductance L1 and the second inductance L2 shown in FIG. 1, but the present disclosure is not limited thereto. In some embodiments, the inductor L21F and the inductor L22F shown in FIG. 4C may correspond to the first inductance L1 and the second inductance L2 shown in FIG. 1, but the present disclosure is not limited thereto.

In some embodiments, the conversion circuit 100F shown in FIG. 4C may be regarded as a configuration in which the conversion circuit 100C shown in FIG. 4A and the conversion circuit 100D shown in FIG. 4B are used simultaneously. In this case, the electronic circuit 90C may be the same as another electronic circuit 90D. The first wiring 120F may correspond to the first wiring 120C shown in the FIG. 4A, second wiring 130F may correspond to the second wiring 130C shown in FIG. 4A, first wiring 121F may correspond to the first wiring 120D shown in the FIG. 4B, second wiring 131F may correspond to the second wiring 130D shown in FIG. 4A, but the present disclosure is not limited thereto.

In some embodiments, the inductor L11F and the inductor L12F may form the input inductor LIN, the inductor L21F and the inductor L22F may form the output inductor LOUT, but the present disclosure is not limited thereto.

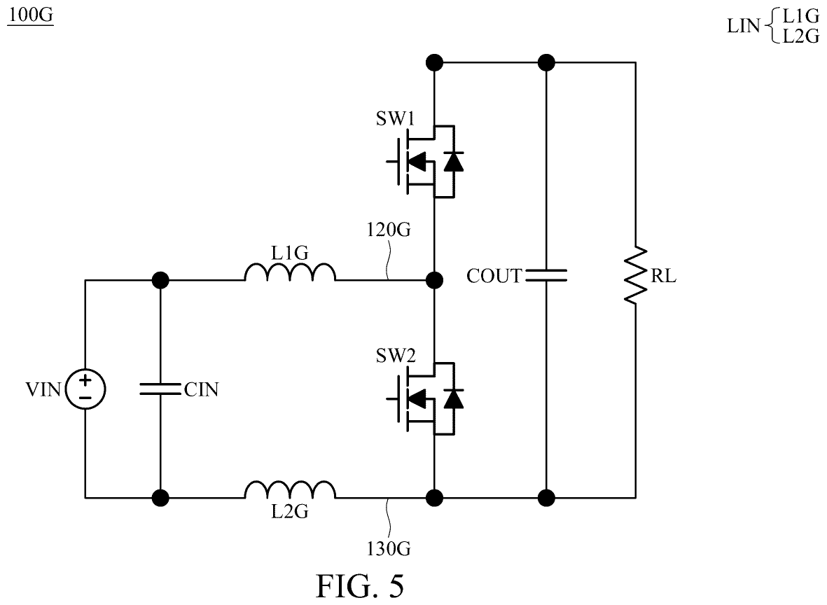

FIG. 5 is a detailed circuit diagram of a conversion circuit according to one embodiment of the present disclosure. As shown in FIG. 5, in one embodiment, the conversion circuit 100G includes the power supply VIN, the capacitor CIN, the inductor LIG, the inductor L2G, the first wiring 120G, the second wiring 130G, the first switch SW1, the second switch SW2, the capacitor COUT, and the resistor RL. The inductor LIG and the inductor L2G may form input inductor LIN.

For example, the inductor LIG, the inductor L2G, the first wiring 120G, and the second wiring 130G shown in FIG. 5 may correspond to the first inductance L1, the second inductance L2, the first wiring 120, and the second wiring 130 shown in FIG. 1, but the present disclosure is not limited thereto.

Please refer to figure land FIG. 5, in one embodiment, compared to FIG. 1, the conversion circuit 100G further includes a first switch SW1 and a second switch SW2. The first wiring 120G is coupled to the power supply VIN, the first wiring 120G is coupled to the first switch SW1 and the second switch SW2, and the first switch SW1 and the second switch SW2 are respectively coupled to an output capacitor COUT and a resistor RL. The at least one electronic component of the electronic circuit includes at least one of an input capacitor CIN and the power supply VIN. The at least one other electronic component of the another electronic circuit includes at least one of the first switch SW1, the second switch SW2, the output capacitor COUT, and the resistor RL.

For example, the input capacitor CIN and the power supply VIN may be connected in parallel with each other, and the output capacitor COUT and the resistor RL may be connected in parallel. The first switch SW1 may be connected in series with the second switch SW2, and the inductor LIG and the inductor L2G may be located between the input capacitor CIN and the second switch SW2, but the present disclosure is not limited thereto.

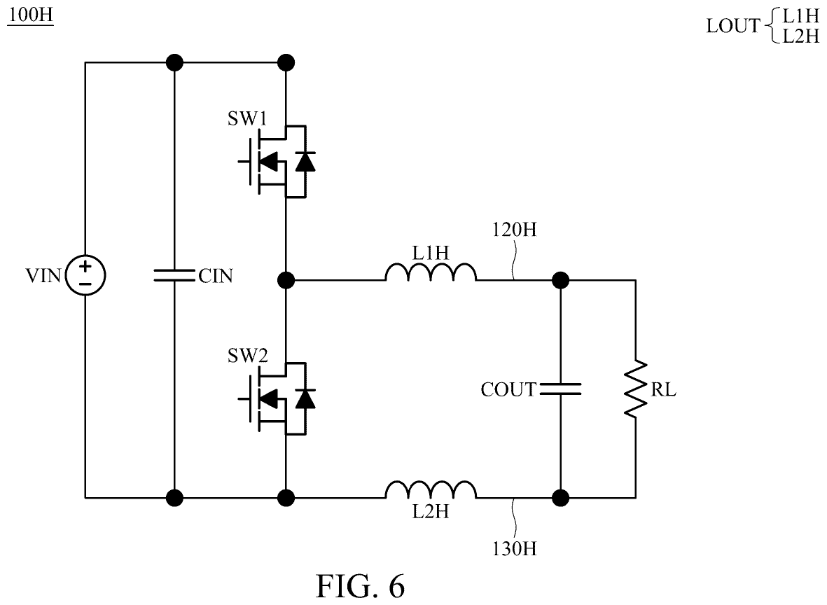

FIG. 6 is a detailed circuit diagram of a conversion circuit according to one embodiment of the present disclosure. As shown in FIG. 6, in one embodiment, the conversion circuit 100H includes the power supply VIN, the capacitor CIN, inductor L1H, the inductor L2H, the first wiring 120H, the second wiring 130H, the first switch SW1, the second switch SW2, the capacitor COUT, and the resistor RL. The inductor L1H and the inductor L2H may form output inductor LOUT.

For example, the inductor L1H, the inductor L2H, the first wiring 120H, the second wiring 130H shown in FIG. 6 may correspond to the first inductance L1, the second inductance L2, the first wiring 120, and the second wiring 130 shown in FIG. 1, but the present disclosure is not limited thereto.

Please refer to FIG. 1 and FIG. 6, in one embodiment, compared to FIG. 1, the conversion circuit 100H further includes a first switch SW1 and a second switch SW2. The first switch SW1 and the second switch SW2 are respectively coupled to a power supply VIN and an input capacitor CIN, the first wiring 120H is coupled to the first switch SW1 and the second switch SW2, and the first wiring 120H is coupled to a resistor RL. The at least one electronic component of the electronic circuit includes at least one of the first switch SW1, the second switch SW2, the input capacitor CIN, and the power supply VIN. The at least one other electronic component of the another electronic circuit includes at least one of an output capacitor COUT and the resistor RL.

For example, input capacitor CIN and power supply VIN may be connected in parallel with each other, output capacitor COUT and resistor RL may be connected in parallel with each other, the first switch SW1 may be connected in series with the second switch SW2, and the inductor L1H and the inductor L2H may be located between the output capacitor COUT and the second switch SW2, but the present disclosure is not limited thereto.

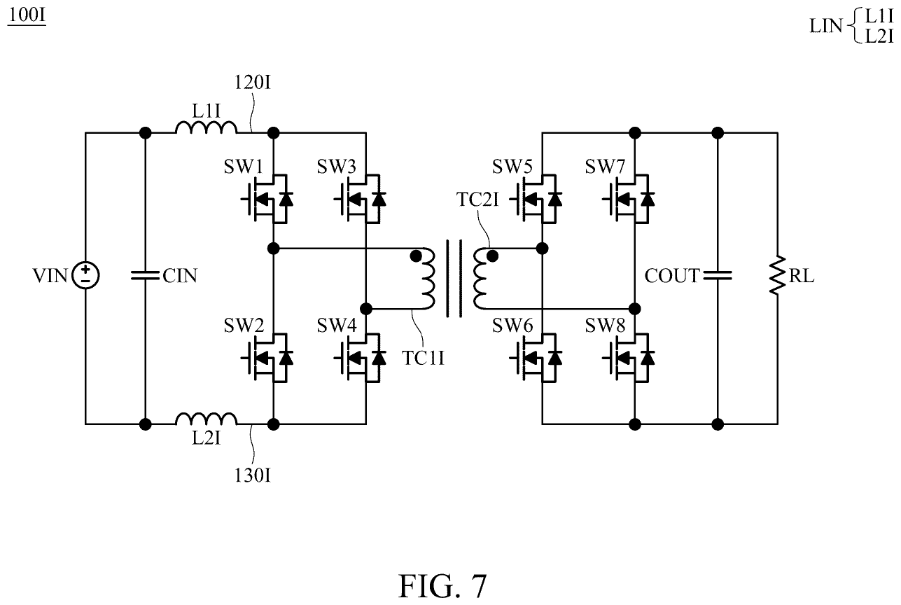

FIG. 7 is a detailed circuit diagram of a conversion circuit according to one embodiment of the present disclosure. As shown in FIG. 7, in one embodiment, the conversion circuit 100I includes the power supply VIN, the capacitor CIN, the inductor LII, the inductor L2I, the first wiring 120I, the second wiring 130I, the first switch SW1, the second switch SW2, the third switch SW3, the fourth switch SW4, the fifth switch SW5, the sixth switch SW6, the seventh switch SW7, the eighth switch SW8, the first transformer coil TC1I, the second transformer coil TC2I, capacitor COUT, and the resistor RL. The inductor LII and the inductor L2I may form input inductor LIN.

For example, the inductor LII, the inductor L2I, the first wiring 120I, and the second wiring 130I shown in FIG. 7 may correspond to the first inductance L1, the second inductance L2, the first wiring 120, and the second wiring 130 shown in FIG. 1, but the present disclosure is not limited thereto.

Please refer to FIG. 1 and FIG. 7, in one embodiment, compared to FIG. 1, the conversion circuit 100I further includes a first switch SW1, a second switch SW2, a third switch SW3, a fourth switch SW4, and a first transformer coil TC1I. The first wiring 120I is coupled to a power supply VIN. The first wiring 120I is coupled to the first switch SW1, the second switch SW2, the third switch SW3, and the fourth switch SW4, and the first switch SW1, and the fourth switch SW4 are respectively coupled to the first transformer coil TC1I. The at least one electronic component of the electronic circuit includes at least one of an input capacitor CIN and power supply VIN. The at least one other electronic component of the another electronic circuit includes at least one of the first switch SW1, the second switch SW2, the third switch SW3, the fourth switch SW4, and the first transformer coil TC1I.

In one embodiment, the conversion circuit 100I further includes a fifth switch SW5, a sixth switch SW6, a seventh switch SW7, an eighth switch SW8, and a second transformer coil TC2I. The fifth switch SW5 and the eighth switch SW8 are respectively coupled to the second transformer coil TC2I, the fifth switch SW5, the sixth switch SW6. The seventh switch SW7 and the eighth switch SW8 are respectively coupled to an output capacitor COUT and a resistor RL. The at least one other electronic component of the another electronic circuit includes at least one of the fifth switch SW5, the sixth switch SW6, the seventh switch SW7, the eighth switch SW8, and the second transformer coil TC2I.

For example, a terminal of the first transformer coil TC1I may be coupled between the first switch SW1 and the second switch SW2, other terminal of the first transformer coil TC1I may be coupled between the third switch SW3 and the fourth switch SW4, a terminal of the second transformer coil TC2I may be coupled between the fifth switch SW5 and the sixth switch SW6, and other terminal of the second transformer coil TC2J may be coupled between the seventh switch SW7 and the eighth switch SW8. The first transformer coil TC1I may be coupled in parallel with the power supply VIN and/or the input capacitor CIN, the second transformer coil TC2I may be coupled in parallel with the output capacitor COUT and the resistor RL, and the inductor LII and the inductor L2I may be located between the input capacitor CIN and the second switch SW2, but the present disclosure is not limited thereto.

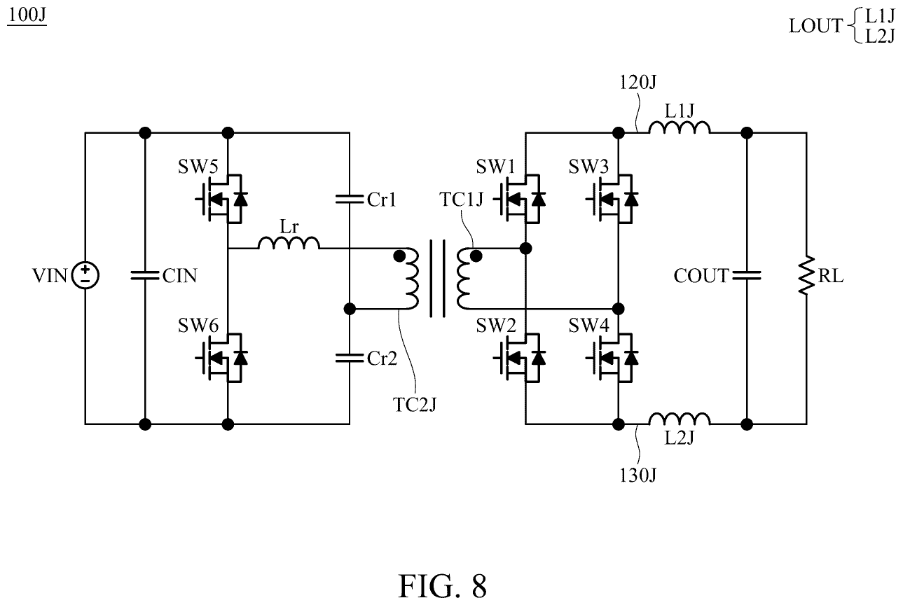

FIG. 8 is a detailed circuit diagram of a conversion circuit according to one embodiment of the present disclosure. As shown in FIG. 8, in one embodiment, the conversion circuit 100I includes the power supply VIN, the capacitor CIN, the inductor L1J, the inductor L2J, the first wiring 120J, the second wiring 130J, the first switch SW1, the second switch SW2, the third switch SW3, the fourth switch SW4, the fifth switch SW5, the sixth switch SW6, the first transformer coil TC1J, the second transformer coil TC2J, the capacitor COUT, the resistor RL, the inductor Lr, the capacitor Cr1, and the capacitor Cr2. The inductor L1J and the inductor L2J may form the output inductor LOUT.

For example, the inductor L1J, the inductor L2J, the first wiring 120J, and the second wiring 130J shown in FIG. 8 may correspond to the first inductance L1, the second inductance L2, the first wiring 120, and the second wiring 130 shown in FIG. 1, but the present disclosure is not limited thereto.

In some embodiments, the inductor Lr may be coupled in series with the second transformer coil TC2J, the inductor Lr may be similar with the first inductance L1 or the second inductance L2 shown in FIG. 1, but the present disclosure is not limited thereto.

Please refer to FIG. 1 and FIG. 8, in one embodiment, compared to FIG. 1, the conversion circuit 100J further includes a first switch SW1, a second switch SW2, a third switch SW3, a fourth switch SW4, and a first transformer coil TC1J. The first wiring is coupled to the first switch SW1, the second switch SW2, the third switch SW3, and the fourth switch SW4, the first switch SW1 and the fourth switch SW4 are respectively coupled to the first transformer coil TC1J, and the first wiring 120J is coupled to a resistor RL. The at least one electronic component of the electronic circuit includes at least one of the first switch SW1, the second switch SW2, the third switch SW3, the fourth switch SW4, and the first transformer coil TC1J. The at least one other electronic component of the another electronic circuit includes at least one of an output capacitor COUT and the resistor RL.

In one embodiment, the conversion circuit 100J further includes a fifth switch SW5, a sixth switch SW6, and a second transformer coil TC2J. The fifth switch SW5 and the sixth switch SW6 are respectively coupled to a power supply VIN and an input capacitor CIN, and the fifth switch SW5 and the sixth switch SW6 are respectively coupled to a first intermediate capacitor Cr1 and a second intermediate capacitor Cr2. The at least one electronic component of the electronic circuit includes at least one of the fifth switch SW5, the sixth switch SW6, the second transformer coil TC2J, the first intermediate capacitor Cr1, and the second intermediate capacitor Cr2.

For example, a terminal of the first transformer coil TC1J may be coupled between the first switch SW1 and the second switch SW2, other terminal of the first transformer coil TC1J may be coupled between the third switch SW3 and the fourth switch SW4. A terminal of the second transformer coil TC2J may be coupled between the fifth switch SW5 and the sixth switch SW6, and other terminal of the second transformer coil TC2J may be coupled between the first intermediate capacitor Cr1 and the second intermediate capacitor Cr2. The first transformer coil TC1J may be coupled in parallel to the output capacitor COUT and/or the resistor RL, the second transformer coil TC2J may be coupled in parallel to the input capacitor CIN and the power supply VIN, and the inductor L1J and the inductor L2J may be located between the output capacitor COUT and the fourth switch SW4, but the present disclosure is not limited thereto.

Please refer to FIG. 5 to FIG. 8, in one embodiment, the conversion circuit is used in one of a boost-type conversion device, a buck-type conversion device, a current-fed conversion device, and a resonant-type power conversion device.

For example, the conversion circuit 100G shown in FIG. 5 may be a boost-type converter, the conversion circuit 100H shown in FIG. 6 may be a buck-type converter, the conversion circuit 100I shown in FIG. 7 may be a current-fed converter, and the conversion circuit 100J shown in FIG. 8 may be a resonant converter, but the present disclosure is not limited thereto.

In one embodiment, the first wiring 120I or 120J and the second wiring 1301 or 130J are located on the same side of the transformer. The transformer includes the first transformer coil TC1I or TC1J and the second transformer coil TC2J or TC2J.

For example, the first inductance LII or L1J may be located on one side of the transformer, the second inductance L21 or L2J may be located on one side of the transformer, but the present disclosure is not limited thereto.

Therefore, according to the technical content of the present disclosure, the conversion circuit shown in the embodiment of the present disclosure can achieve the effect reducing conductor material loss by optimizing the arrangement of the first wiring and the second wiring.

Ordinal numbers in this specification and the claims, such as “first,” “second,” “third,” etc., do not imply any sequential order among themselves. They are only used to denote and distinguish two different elements having the same name.

Although specific embodiments of the present application are disclosed in the foregoing embodiments, they are not intended to limit the present application. A person having ordinary skill in the art to which the present application pertains may make various changes and modifications thereto without departing from the principle and spirit of the present application. Therefore, the protection scope of the present application shall be subject to the scope defined by the accompanying claims.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A conversion circuit, configured in a power converter, the conversion circuit comprising:
a first inductor core, comprising:
a core pillar;
a first wiring, wherein the first wiring surrounds the core pillar to form a first inductor coil; and
a second wiring, wherein the second wiring surrounds the core pillar to form a second inductor coil, and the first wiring and the second wiring are located in same electrically conductive circuit;
wherein a power signal of the first wiring transmits into an electronic circuit and transmits out to the second wiring.

2. The conversion circuit as claimed in claim 1, wherein
the first inductor core further comprises a first pillar and a second pillar;
wherein the core pillar is located between the first pillar and the second pillar, and the first pillar, the core pillar, and second pillar are arranged along a normal line;
wherein the first wiring and the second wiring respectively pass through the normal line;
wherein the first wiring is arranged between the first pillar and the core pillar.

3. The conversion circuit as claimed in claim 2, wherein
the first pillar comprises a first cross-sectional area, the core pillar comprises a second cross-sectional area, and the second pillar comprises a third cross-sectional area;
wherein the second cross-sectional area is greater than the first cross-sectional area, the second cross-sectional area is greater than the third cross-sectional area.

4. The conversion circuit as claimed in claim 3, wherein
the first cross-sectional area is equal to the third cross-sectional area.

5. The conversion circuit as claimed in claim 3, wherein
the first inductor core further comprises a groove, and the groove is configured to receive at least one of capacitor;
wherein the first wiring and the second wiring are coupled to the at least one of capacitor.

6. The conversion circuit as claimed in claim 5, wherein
the groove is arranged adjacent to the core pillar.

7. The conversion circuit as claimed in claim 5, wherein
the groove is disposed at a central portion of the first inductor core.

8. The conversion circuit as claimed in claim 2, wherein
the electronic circuit comprises at least one electronic component, and the electronic circuit is respectively coupled to one terminal of the first wiring and one terminal of the second wiring;
wherein another electronic circuit comprises at least one other electronic component, and the another electronic circuit is respectively coupled to other terminal of the first wiring and other terminal of the second wiring.

9. The conversion circuit as claimed in claim 8, further comprising:
a first switch; and
a second switch;
wherein the first wiring is coupled to a power supply, the first wiring is coupled to the first switch and second switch, and the first switch and the second switch are respectively coupled to an output capacitor and a resistor;
wherein the at least one electronic component of the electronic circuit comprises at least one of an input capacitor and the power supply;
wherein the at least one other electronic component of the another electronic circuit comprises at least one of the first switch, the second switch, the output capacitor, and the resistor.

10. The conversion circuit as claimed in claim 8, further comprising:
a first switch; and
a second switch;
wherein the first switch and the second switch are respectively coupled to a power supply and an input capacitor, the first wiring is coupled to the first switch and the second switch, and the first wiring is coupled to a resistor;
wherein the at least one electronic component of the electronic circuit comprises at least one of the first switch, the second switch, the input capacitor, and the power supply;
wherein the at least one other electronic component of the another electronic circuit comprises at least one of an output capacitor and the resistor.

11. The conversion circuit as claimed in claim 8, further comprising:
a first switch;
a second switch;
a third switch;
a fourth switch; and
a first transformer coil;
wherein the first wiring is coupled to a power supply, the first wiring is coupled to the first switch, the second switch, the third switch, and the fourth switch, and the first switch and the fourth switch are respectively coupled to the first transformer coil;
wherein the at least one electronic component of the electronic circuit comprises at least one of an input capacitor and the power supply;
wherein the at least one other electronic component of the another electronic circuit comprises at least one of the first switch, the second switch, the third switch, the fourth switch, and the first transformer coil.

12. The conversion circuit as claimed in claim 11, further comprising:
a fifth switch;
a sixth switch;
a seventh switch;
an eighth switch; and
a second transformer coil;
wherein the fifth switch and the eighth switch are respectively coupled to the second transformer coil;
wherein the fifth switch, the sixth switch, the seventh switch and the eighth switch are respectively coupled to an output capacitor and a resistor;
wherein the at least one other electronic component of the another electronic circuit comprises at least one of the fifth switch, the sixth switch, the seventh switch, the eighth switch and the second transformer coil.

13. The conversion circuit as claimed in claim 8, further comprising:
a first switch;
a second switch;
a third switch;
a fourth switch; and
a first transformer coil;
wherein the first wiring is coupled to the first switch, the second switch, the third switch, and the fourth switch;
wherein the first switch and the fourth switch are respectively coupled to the first transformer coil, and the first wiring is coupled to a resistor;
wherein the at least one electronic component of the electronic circuit comprises at least one of the first switch, the second switch, the third switch, the fourth switch, and the first transformer coil;
wherein the at least one other electronic component of the another electronic circuit comprises at least one of an output capacitor and the resistor.

14. The conversion circuit as claimed in claim 13, further comprising:
a fifth switch;
a sixth switch; and
a second transformer coil;
wherein the fifth switch and the sixth switch are respectively coupled to a power supply and an input capacitor, and the fifth switch and the sixth switch are respectively coupled to a first intermediate capacitor and a second intermediate capacitor;
wherein the at least one electronic component of the electronic circuit comprises at least one of the fifth switch, the sixth switch, the second transformer coil, the first intermediate capacitor, and the second intermediate capacitor.

15. The conversion circuit as claimed in claim 2, wherein
the conversion circuit is used in one of a boost-type conversion device, a buck-type conversion device, a current-fed conversion device, and a resonant-type power conversion device.

16. The conversion circuit as claimed in claim 9, wherein
the first wiring and the second wiring are located on same side of a transformer.

17. The conversion circuit as claimed in claim 9, wherein
a first current value of the first wiring is equal to a second current value of the second wiring.

18. The conversion circuit as claimed in claim 2, wherein
a number of turns of the first inductor coil of the first wiring is not equal to a number of turns of the second inductor coil of the second wiring.

19. The conversion circuit as claimed in claim 2, wherein
a number of turns of the first inductor coil of the first wiring is greater than a number of turns of the second inductor coil of the second wiring.

20. The conversion circuit as claimed in claim 2, wherein
a number of turns of the first inductor coil of the first wiring is equal to a number of turns of the second inductor coil of the second wiring.
